(19) United States
(12) Patent Application Publication
(10) Pub. No.: US 2016/0033043 A1
(43) Pub. Date: Feb. 4, 2016

(54) POLYUREA GASKET AND GASKET TAPE AND A METHOD OF MAKING AND USING THE SAME

(71) Applicant: AVIATION DEVICES & ELECTRONIC COMPONENTS, L.L.C., FORT WORTH, TX (US)

(72) Inventors: JEFF BUSBY, MILLSAP, TX (US); MIKE DRY, FORT WORTH, TX (US); KENT BOOMER, ALEDO, TX (US); MATT BOYD, FORT WORTH, TX (US)

(21) Appl. No.: 14/815,646

(22) Filed: Jul. 31, 2015

Related U.S. Application Data
(60) Provisional application No. 62/031,916, filed on Aug. 1, 2014.

(51) Int. Cl. F16J 15/10; B64F 5/00; F16J 15/12

(52) U.S. Cl. CPC F16J 15/104; F16J 15/102; F16J 15/108; F16J 15/122; B64F 5/0009

(57) ABSTRACT

A gasket or tape material for sealing between two members. The gasket or tape material, in one embodiment, includes a skeletal member and/or metallic and/or non-metallic particles. Enclosing the skeletal member and/or particles is a flexible, compressible resilient polyurea body member having a tacky outer surface, the tacky outer surface for engagement between the two members. The resilient body may be comprised of polyurea. The skeletal member may be comprised of a metallic or a non-metallic material, woven or non-woven metallic or non-metallic.

### RELATED APPLICATIONS

This application claims priority from U.S. Patent Application No. 62/031,916, filed Aug. 1, 2014. This patent application incorporates by reference U.S. Pat. Nos. 6,530,577; 6,695,320; and 7,229,516, to the extent they do not conflict with the specification set forth herein.

### FIELD OF THE INVENTION

A gasket and sealant material, more specifically, a gasket material comprising, in one embodiment, a resilient, pliable body made up of a polyurea and having a skeletal member embedded therein.

### BACKGROUND OF THE INVENTION

A gasket is a sealing member for use between two mating surfaces to help prevent the movement of fluid or gas between the mating surfaces. Gaskets may be pre-cut to fit a workpiece or provided in rolls which are referred to as gasket tape and are cut to length at the time of application to the workpiece. Gaskets are often used on vehicles such as aircraft to prevent moisture from corroding the sealed off areas and the mating surfaces. For example, on the outside skin of an aircraft, antenna are often mounted to assist in communications between the aircraft and a remote location. Such antennas often consist of a generally tabular mounting plate having an inner and outer surface, the inner surface mating to the outer skin of the aircraft and having an electrical connector projecting from the inner surface. The electrical connector is intended to fit partially into the interior of the aircraft through a small opening in the aircraft skin designed for such purpose. The electrical connector element will connect to the appropriate electrical circuit in the aircraft. On the outer surface of the mounting plate, and often incorporated with the mounting plate, is the antenna transceiving member for transmitting and/or receiving radio frequencies.

Traditionally, the antenna is removably mounted to the aircraft through typical threaded fasteners. Holes in the tabular mounting plate of the antenna support the threaded fasteners which pass into the aircraft's skin, typically threading into blind nuts mounted against the inside surface of the aircraft's skin.

Gaskets typically are provided for covering a portion of the “footprint” of the antenna or other aircraft part. When the fasteners are tightened down, they compress the gasket typically with some deformation.

However, conventional gaskets often have a number of shortcomings which applicants novel gasket material overcomes. These shortcomings include allowing moisture to penetrate the area between the parts under compression. Often, for example, a site of corrosion is the junction between the antenna inner surface and the electrical connective elements of the antenna. In some cases, moisture has been found to “pool” in this area, accelerating corrosion.

Flexibility, resiliency, durability, compressibility and pliability are other favorable properties which help affect a good seal between the mating surfaces. All of these beneficial properties should have a useful life that is reasonable in view of operating conditions (multiple thermal and pressure cycling) and aircraft maintenance schedules. The gasket should be inert, that is non-reactive with the work pieces (typically aluminum) as well as non-reactive to water, including salt water.

Not surprisingly, it has proven to be a challenge to develop a gasket with these properties that will survive repeated heat and pressure cycling (as the aircraft climbs and descends), structural flexing, UV light exposure, and vibration while protecting the aircraft components and having a sufficient useful life in which its beneficial properties remain undiminished.

### SUMMARY

Applicants provide for all of the above properties in an aircraft gasket and gasket tape and a novel method of manufacturing the aircraft gasket and gasket tape. Gasket tape is gasket material that is rolled into tape rather than precut to the pattern of the mating surfaces. The tape may have a skeleton or be without a skeleton. Like the gasket, it has a body that is tacky and, in some embodiments, may be stretchable. Applicants further provide for a method of using the preformed gasket with a thin, settable polyurea gel to, in some cases, help insure a waterproof seal.

Applicants provide a gasket and gasket tape, in some embodiments, with the following beneficial properties: elasticity (with memory), low water absorption (less than 1% over its working life), low water or no water content, and leak free (especially of silicon oil).

The elasticity and pliability helps make an effective seal between the two mating surfaces as compression against such elasticity helps seal over mating surface irregularities and allows structural flexing or vibration of the two surfaces while maintaining a good seal. The maintenance of this elasticity property is important since the surfaces undergo thermal expansion and contraction during repeated altitude and temperature changes which also causes relative movement (flexing) between the mating surfaces.

Tackiness has been found beneficial since there is also vibration and flexing of the mating surfaces. Tackiness and resiliency provide a better seal should there be a slight separation between the mating surfaces.

In one embodiment, Applicant's novel gasket consists of at least two parts. The first part comprises a skeletal member—in some embodiments, an open-weave or unwoven mesh, foam or other suitable member and an open-woven mesh made of a metallic material or a non-metallic fabric such as fiberglass, carbon fiber mesh or the material set forth in published US Application No. 2015/0069722, incorporated herein by reference.

In one embodiment, the second part of applicant's novel gasket is a two-component polyurea mix curing to form a flexible, resilient gel body member typically formed around and through and about the skeletal member so that the skeletal member is substantially encapsulated within the resilient body member and gives some structure and form to the gasket.

A polyurea may be defined as:
“A polyurea coating/elastomer is that derived from the reaction product of an isocyanate component (such as a diisocynate) and a resin blend component. The isocyanate can be aromatic or aliphatic in nature. It can be monomer, polymer, or any, variant reaction of isocyanates, quasi-prepolymer or a prepolymer. The prepolymer, or quasi-prepolymer, can be made of an amine-terminated polymer resin. The resin blend must be made up of amine-terminated polymer resins, and/or amine-terminated chain extenders. The resin blend may also contain additives, or non-primary components. Normally, the resin blend will not contain a catalyst(s).”

The gasket and gasket tape may be tabular in shape and the skeletal member and resilient body share a tabular shape and plane. In one embodiment, when viewed in cross-section, Applicants skeletal member is not centered between the two opposed tabular surfaces of the gasket (or gasket tape), but instead is closer to one surface than the other. It is believed that this property provides selective retentivity to the material.

The resilient body is typically comprised of a semi-solid gelatin polyurea two-component elastomer, typically about between about 20 and 150 (cone penetration using a 37½ gram half-cone), in one embodiment, and about 90-120 in another embodiment, and having a cured surface tackiness (to the touch) and a peel strength between about 2 and 7 pounds per inch-width. Tackiness allows some adhesion to a metal mating surface, but will release easily and leave no residue upon release. The resilient body will not undergo dessication, does not leak oil, but retains memory and does not absorb more than about one percent by weight water. In a preferred embodiment, the body of the gasket or tape is a self-curing two-component polymer mix that will cure between about 1 to 11 minutes.

A gasket or tape is disclosed for sealing between two members, the two members under compression and being two parts of an aircraft, the gasket material comprising a flexible skeletal member; and a flexible, deformable, elastomeric resilient polyurea body member having a tacky outer surface, the body member for substantially enclosing the skeletal member with a self-curing mix of an isocynate component and an amine terminated component, the resilient body member having a tacky top surface and a tacky bottom surface.

The body may have a peel strength between about 2 and 7 pounds/inch width. The mix may have a pre-cured viscosity, when coming out of the nozzle of an applicator of between about 200 and 4500 Cps. The body may have a hardness after curing of between about 40 and 150 (37.5 gram half cone penetrometer). The body is typically free from volatile organic compounds (VOC's) and solvents. The self-curing mix will cure, in some embodiments, between about 3 and 11 minutes. The skeleton member may be a mesh (non-metal or metal), a metallic or non-metallic open cell foam, or a perforated or expanded sheet. The body may include electrically conductive particles. The flexible skeletal member may be encapsulated in the body such that the body is closer to one of the top or bottom surface than the other. A skin may be provided for placement on one of the top or bottom surfaces. The skin will allow some seepage of the body member therethrough, when under compression. One of the top or bottom surface may have a first peel strength and the other a second peel strength, the two peel strengths being different. The gasket can withstand multiple thermal cycles and retain its resiliency and tackiness.

An assembly is provided comprising a first aircraft part having a first surface, a second aircraft part having a second surface and a gasket or gasket tape for sealing between the two parts, the two parts under compression. The gasket or gasket tape material has a flexible skeletal member; and a flexible, deformable, elastomeric resilient polyurea body member having a tacky outer surface, the body member for substantially enclosing the skeletal member with a self-curing mix of an isocynate component and an amine terminated component. The resilient body member has a tacky top surface and a tacky bottom surface. Fasteners are used for engaging the two parts and providing compression on the gasket or gasket tape. The body typically has a hardness after curing of between about 40 and 150 (37.5 gram half, cone penetrometer). In some embodiments, the first aircraft part is a floorboard and the second aircraft part is a floorboard support surface or the first aircraft part is an outer surface of an aircraft and the second aircraft part is an aircraft antenna, which may include a coaxial cable for passing through the outer surface and connecting to the aircraft antenna, the coaxial cable may be wrapped in a stretchable foam tape substantially encapsulated by a polyurea body.

A method of making a gasket or gasket tape is shown, the method comprising the steps of laying a skeletal member on a flat, release/support surface, combining an uncured, a self-curing, two part, gas bubble-free, polyurea mix onto the skeletal member, such that the mix substantially encapsulates the skeletal member before curing, allowing the mix to cure; and shaping the encapsulated skeleton to the shape of a workpiece.

### BRIEF DESCRIPTION OF THE DRAWINGS

FIGS. 1 and 1A illustrate polyurea bodied gaskets and their use.

FIG. 1B illustrates the variety of skeletons that may be used and the optional addition of conductive particles to enhance conductivity.

FIG. 2 is a cross-sectional view of one embodiment of Applicant's preformed gasket.

FIG. 3 is a side elevational view of Applicant's preformed gasket in use.

FIGS. 4, 5, and 6 are elevational views of various “footprints” of Applicant's preformed polyurea bodied gaskets.

FIG. 7 is a cross-sectional elevational view of Applicant's gasket tape.

FIG. 8 is a perspective view of a step in the manufacture of Applicant's preformed gaskets.

FIG. 9 is a perspective view of another step in the process of manufacturing Applicant's preformed gaskets.

FIG. 9A is a side elevational view of a table for use in the method of manufacturing Applicant's gasket material and illustrating Applicant's gasket material on the upper surface thereof.

FIG. 10 is a perspective view of a manufacturing step in preparing Applicant's gasket material.

FIG. 11 is a perspective view of a step in the manufacturing of Applicant's preformed gaskets.

FIG. 12 is a side elevational view of a step undertaken in preparation for manufacturing Applicant's gasket material

FIG. 13 is a side elevational view of a table for use in the manufacture of Applicant's gasket tape illustrating the stretching and clamping of a woven, non-metallic fiberglass member against the upper surface of the table, the table upper surface having been covered with a release film.

FIG. 14 is a perspective view of the cutting of gasket tape stock into tape.

FIG. 14A illustrates an alternate preferred method of manufacturing a gasket or gasket type of the present invention.

FIGS. 15, 15A, and 15B illustrate a method of using Applicant's preformed gasket with a liquid, curable two-component polyurea mix with a preformed gasket to provide an effective gasket seal between an aircraft skin and an aircraft antenna.

FIGS. 16A, 16B, 16C, 16D, 16E, 16F, and 16G illustrate environments in which Applicant's gasket or gasket tape may be used in an aircraft.

### DETAILED DESCRIPTION OF EXEMPLARY EMBODIMENTS

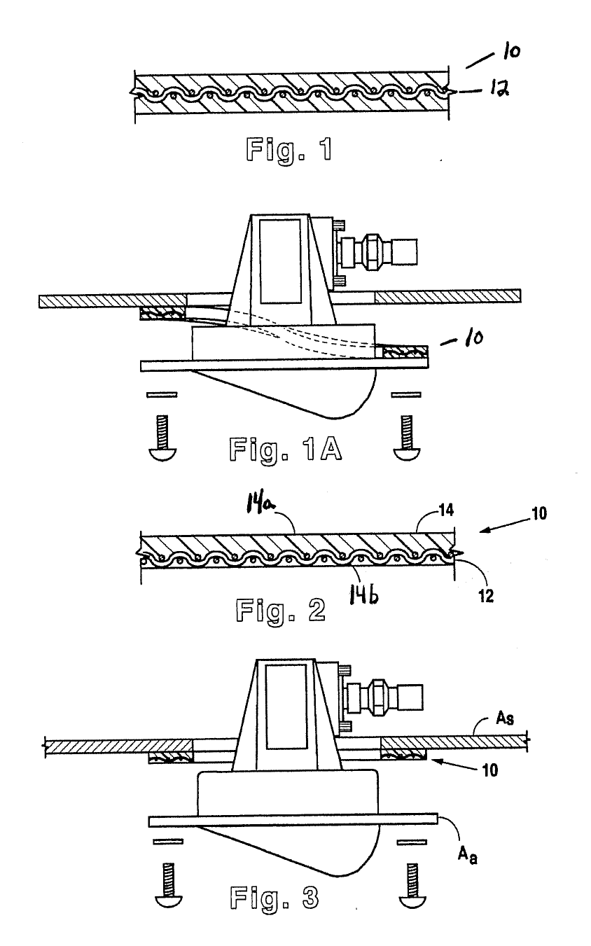

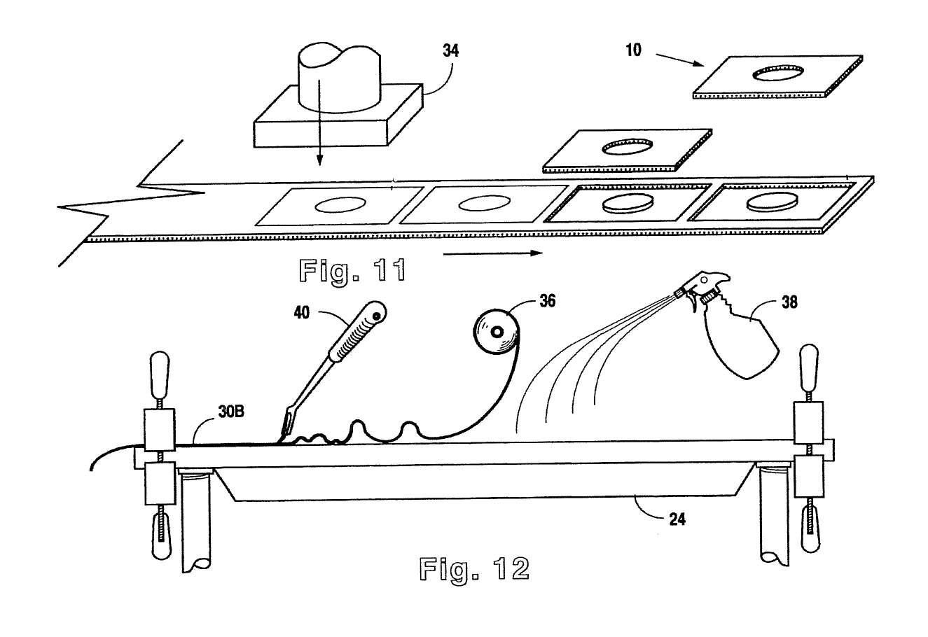

As seen in FIGS. 1 and 1A, one embodiment of Applicant's preformed gasket 10 or gasket tape 16 (FIG. 7) may include a skeletal member 12, which may be metallic or nonmetallic. One typical skeletal member 12a is a woven aluminum mesh of thickness typically between about 0.011 to 0.025 inch. A mesh 12a (see FIGS. 1B, 13, and 14) may be woven fiberglass or woven carbon fiber, in one example, as when used in Applicant's gasket tape 16 typically between about 7 and 20 mil thick.

Substantially encapsulating skeletal member 12 is a resilient body 14 typically a soft, tacky semisolid polyurea elastomer gel and more typically a resilient body formed from a two-component self-curing polyurea mix. The resilient body may include a first surface 14a and an opposed second surface 14b, the two surfaces may comprise parallel spaced apart planes. A typical thickness of Applicant's preformed gasket 10 is about 0.032 inches to 0.060 inches before compression between two parts or elongation of the tape. The preformed gasket and tape share the same resilient body 14 and both have a sticky or tacky surface. Typical peel strength is in the range of about 2.0 to 7.0 pounds/inch width, in one embodiment, between about 0.5 and 3.0, in a second embodiment.

FIG. 1B illustrates a number of skeletons 12 that may be used with Applicant's resilient, tacky polyurea body 14 to form a gasket or gasket tape 10/16. In one embodiment, skeleton 12a is a woven mesh which has multiple openings around woven members, which members may be metallic or non-metallic. In one embodiment, skeleton 12a may be woven fiberglass which woven fiberglass is made up of individual strands or individual strands with multiple plys or may be made up of metallic strands such as aluminum. In a second embodiment, skeleton 12b may be an open cell metal or non-metallic foam such as those found in U.S. Pat. No. 3,616,841 and PCT/US2015/040917, incorporated herein by reference. In a third embodiment, skeleton 12c may be expanded or perforated materials such as expanded metal. Resilient body 14 substantially encloses or encapsulates any of skeletons 12a/12b/12c or any other skeleton 12 that may take up the uncured mix so as to become substantially encapsulated. The gasket or gasket tape may be used between two pieces 15/17 of an aircraft, under compression with facing surfaces 15a/17a compressing and deforming body 14. In one embodiment, compression between about 50-500 psi is provided and the resulting deformation and squeezing of the body brings the two surfaces 15a/17a into contact with the skeleton.

Suitable metals for the skeleton include, for example, copper, nickel, silver, aluminum, bronze, steel, tin, or an alloy or combination thereof. The metal fibers can also be coated with one or more of the foregoing metals. The electrically conductive fibers can be non-conductive fibers having an electrically-conductive coating, metal wires, carbon fibers, graphite fibers, inherently-conductive polymer fibers, or a combination thereof. In one aspect, the non-conductive fibers of the mesh of skeleton 12a can be prepared from cotton, wool, silk, cellulose, polyester, polyamide, nylon, polyimide, or a combination thereof, and the electrically-conductive coating can be copper, nickel, silver, aluminum, tin, carbon, graphite, or an alloy or combination thereof. In another aspect, the metal wires of the mesh of the skeleton are copper, nickel, silver, aluminum, bronze, steel, tin, or an alloy or combination thereof, or one or more of copper, nickel, silver, aluminum, bronze, steel, tin, or an alloy or combination thereof coated with one or more of copper, nickel, silver, aluminum, bronze, steel, tin, or an alloy or combination thereof.

Conductive particles 19 (see FIG. 1B) may include but are not limited to electrically conductive metal-based fillers such as pure silver, silver plated gold; silver plated copper, nickel or aluminum, for example, silver plated aluminum core particles or platinum plated copper particles; metal plated glass, plastic or ceramics such as silver plated glass microspheres, metal plated alumina or metal plated plastic microspheres; metal plated mica and other such metal conductive particles. Nonmetal materials such as carbon black and graphite combinations of particles may meet a selected conductivity, hardness and other parameters desired for a particular application. The size and shape of the electrically conductive particles is not critical, they may be spherical, flayed, platelet, irregular or fibrous (such as chopped fibers). The particle size in one embodiment may be between about 0.250 microns to about 250 microns. In some embodiments, the loading of the particles in the elastomeric polyurea may be from about 10-80% volume. The conductive particles may be mixed with the polyurea in a pre-cured condition in one or both parts prior to application. In one embodiment, the particles are the sacrificial metal pigments of the composition found in US2013/0168612, incorporated herein by reference. This reference discloses a coated sacrificial-metal pigment having a particle size ranging from about 2 to 100 microns coated with an effective amount of at least one metal oxide selected from the group consisting of chromium oxide, zirconium oxide and mixtures of chromium and zirconium oxides, the uncoated metal pigment selected from the group consisting of zinc, magnesium, iron, aluminum, silver, copper and nickel, said metal oxide coating derived from an aqueous composition consisting essentially of, in parts by weight, from 0.01 to 22 arts of a trivalent chromate, from 0.01 to 12 parts of hexafluorozirconate, from 0.01 to 12 parts of a fluorocarbon selected from the group consisting of tetrafluoroborate, hexafluorosilicate, and the hexelluorotitanates, from about 0.0 to 12 parts of a divalent zinc compound and from 0.0 to 5.0 parts of a water soluble corrosion inhibitor.

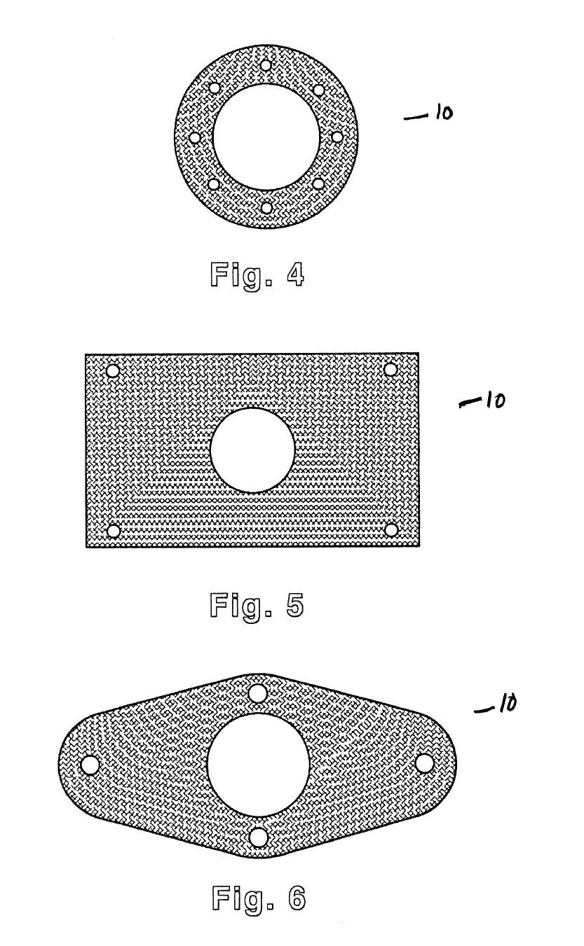

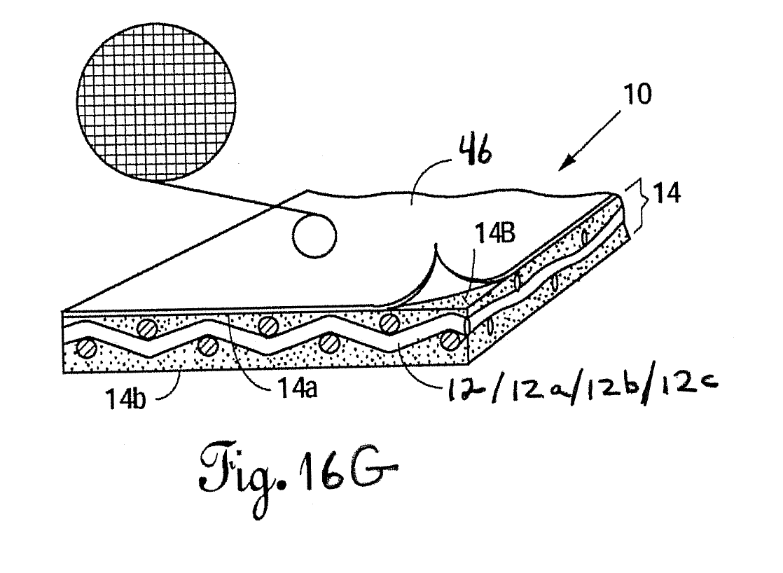

FIGS. 3 and 16F illustrate Applicant's gasket 10 as it is used to mount between two mating surfaces, here aircraft skin As and aircraft antenna Aa, with preformed gasket 10 cut to dimensions dictated by the footprint of the antenna. It is placed between the aircraft skin and antenna and fasteners are tightened down typically to between about 15 and 35 inch pounds, to compress and slightly deform (squish out along the gasket edges) the polyurea body of the gasket. FIG. 16F illustrates use of three applications of Applicant's polyurea products, gasket 10, tape 16 (in some embodiments, with a stretchable skeleton, such as encapsulated open cell foam), and a self-leveling, injectable cure in place mix 13. On such self-leveling, cure in place polyurea mix is HT 5509-2, available from Aviation Devices & Electronic Components, LLC located at 3215 W. Loop 820 S, Fort Worth, Tex. 76116, and usable in some embodiments, for making body 14.

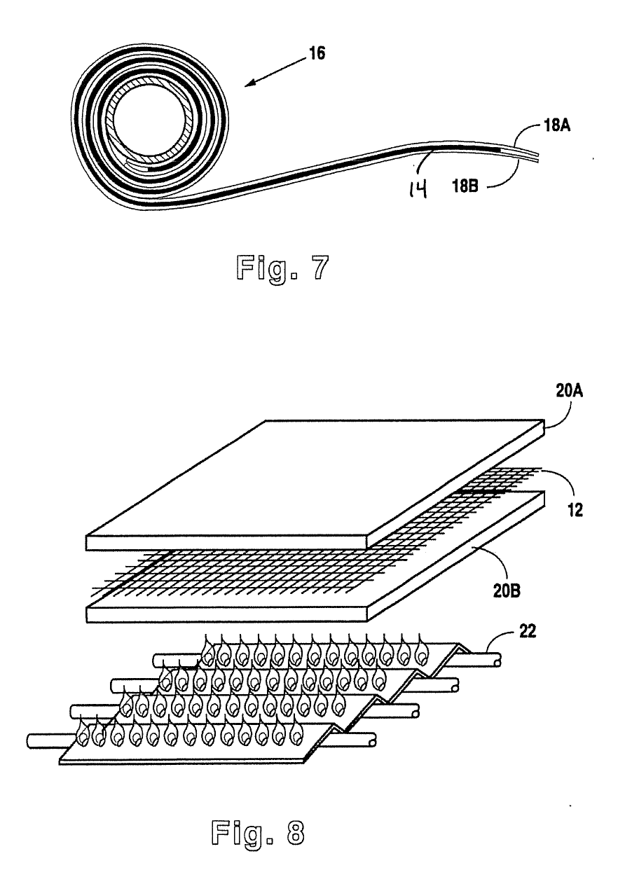

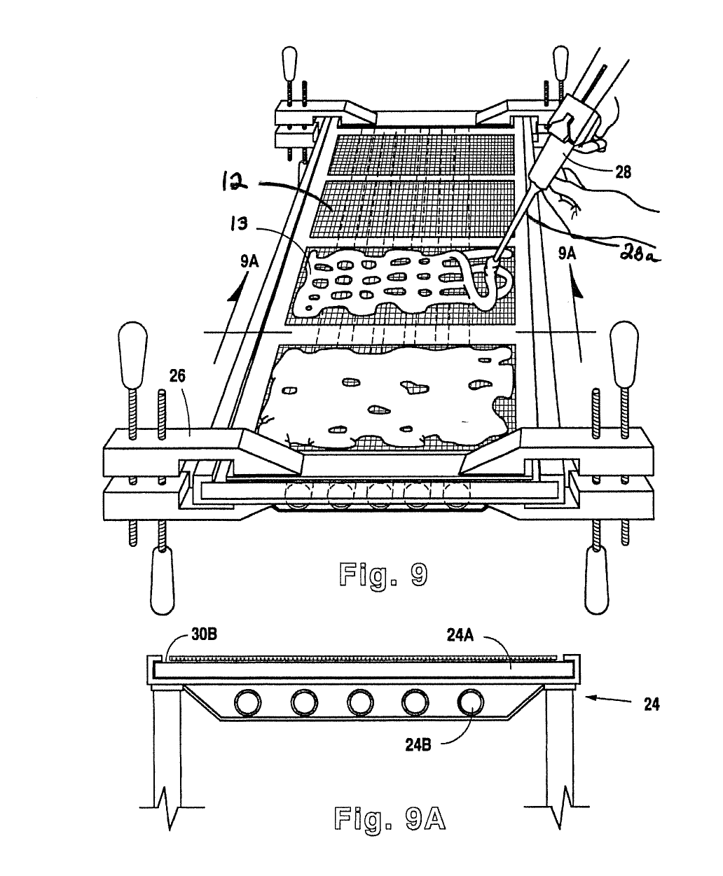

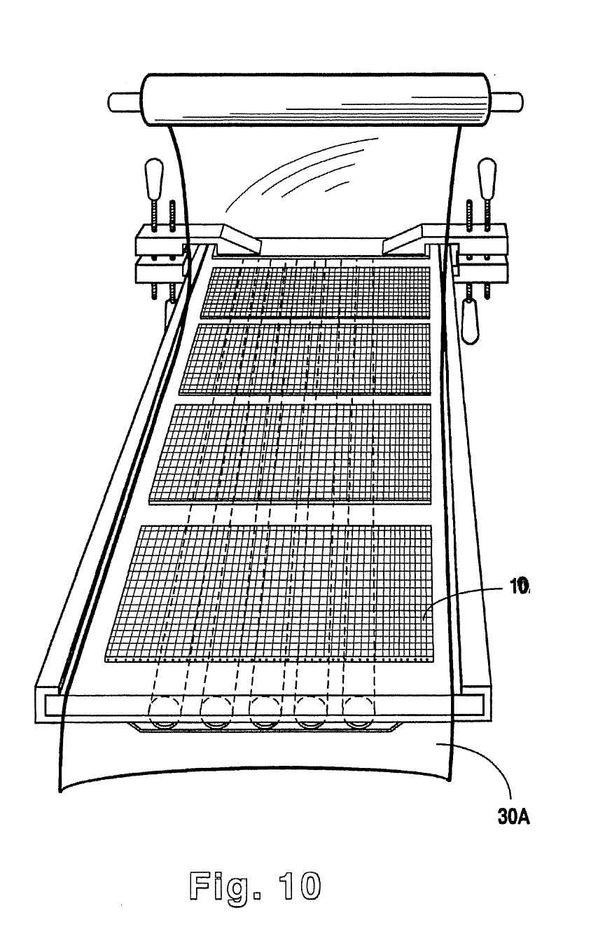

FIGS. 4, 5, and 6 illustrate three “footprints” available for Applicant's performed gasket.

FIG. 7 illustrates the use of Applicant's unique gasket material in tape form 16, rolled up and available to be cut to length for placing between a pair of mating surfaces or as a self-sealing tape for winding or wrapping wire connections (see FIG. 16F). Applicant's tape 16 uses, typically, the same two-component polyurea body as preformed gasket 10 which has surface tackiness and may have a non-metallic mesh 12a, typically woven fiberglass or a saturated open cell foam that may stretch up to 500% (see FIG. 16F) as the foam disclosed in U.S. Pat. No. 7,229,516, incorporated herein by reference in reticulated polyurethane foam, in one embodiment, 100 ppi from Reilly Foam, Eagleville, Pa.

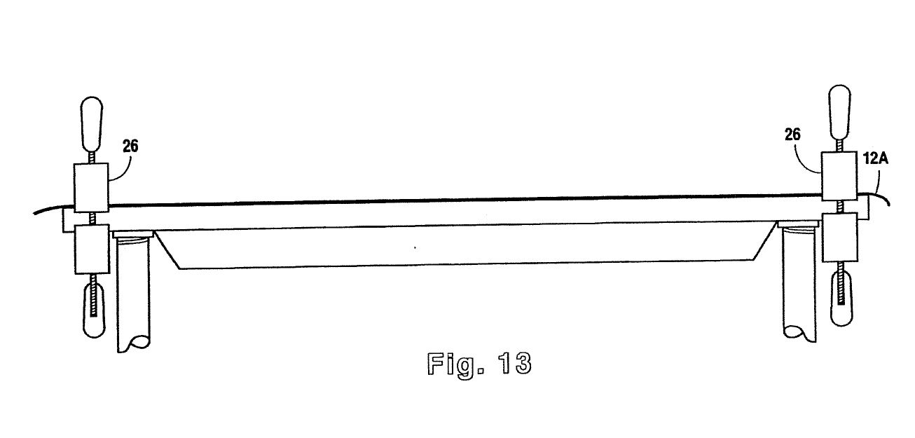

FIGS. 8, 9, 10, 11, 12, 13, 14, and 15A illustrate a method of producing Applicant's precut gasket 10.

The first step is an (optional) flattening step. The purpose of this step is to flatten out a skeletal member 12. The way in which this may be done, if the skeletal member is metallic wire mesh, is to place the wire mesh 12 between two flat weighed members 20a and 20b and then placing the weighed members with the wire mesh between them in an oven 22. The wire mesh is typically 18 inches by 24 inches and the weighed members are typically ¼″ stainless steel plates. The mesh and weighed member are typically laid flat in an oven 22 and heated 60 degrees F. for about 30 minutes. This anneals the metallic wire mesh and keeps it flat. The metal plate and the wire mesh are then removed form the oven and allowed to cool. Following cooling the weighed plates are removed and the wire mesh is ready for placement onto flat table 24.

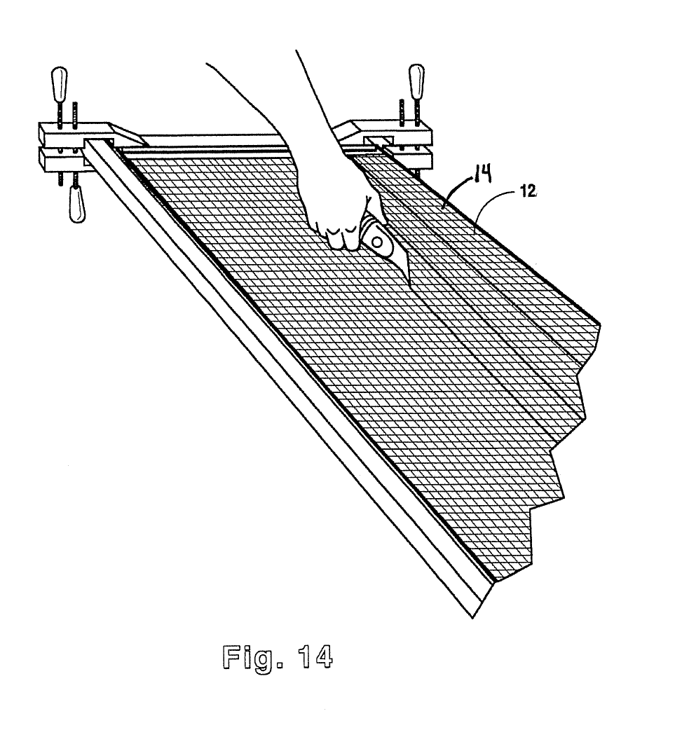

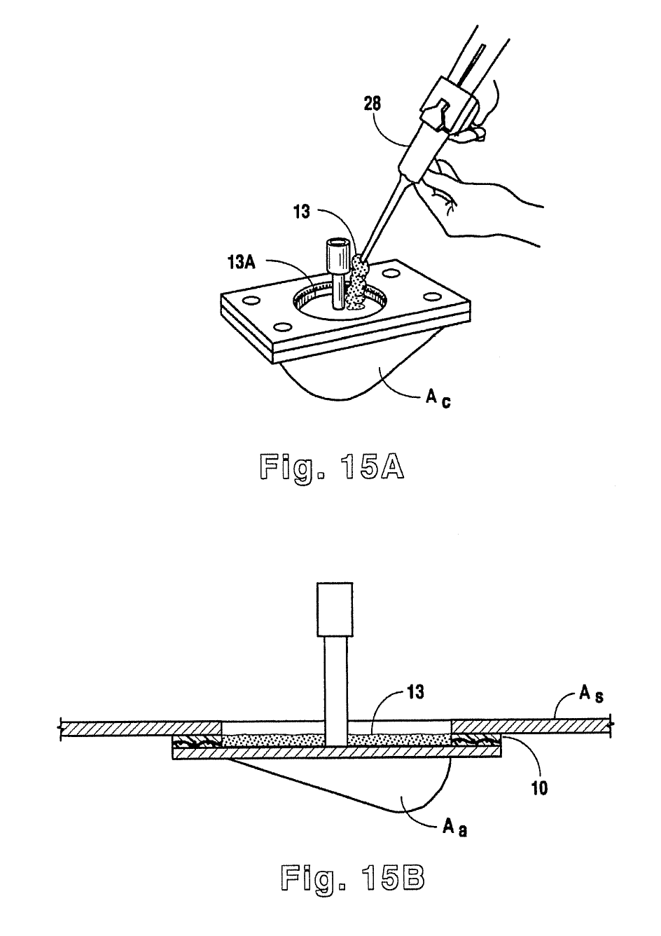

At this point it is germane to examine the nature of one embodiment of flat table 24 in more detail. With reference to FIG. 9A, table 24 has legs and a table top. The table top typically may include a flat transparent glass member 24a with a flat upper surface. It may also include beneath the glass member 24a longitudinal aligned fluorescent lights 24b for visibility. Before placement of wire mesh 12 onto the glass table top a release sheet, such as an FEP sheet (fluorinated ethylene propylene) film is applied to the table top. The FEP film is inert and will not stick to the uncured polyurea mix or the cured mix and will allow a clean removal of the cured polyurea mix, which comprises the resilient body, from the table top. It is noted with reference to FIG. 12, the FEP film may be applied to the flat glass table top 24a from a roll, after Windex® an ammonia based cleaner 38 is applied to the surface of a table top and a squeegee 40 is used to squeeze out any air bubbles. This is done to insure a flat, bubble free surface for gasket formation. Thus, it is seen with reference to FIGS. 9A and 12 that table top 24a has been prepared prior to the placement of the flattened wire mesh on top thereof, with an FEP or otherwise suitable release film which will lay flat to the table top, be inert to the cure mix and allow the gasket material to release therefrom.

The next step in the manufacture of the preformed gasket, may be called the “mixing and pouring” step and is best illustrated with reference to FIG. 9. In FIG. 9 it is seen that a mix applicator 28 containing a curable mix 13 of resilient body such as a mix of diisocyanate and amine terminated polymer resin as set forth above, is applied to the skeleton through the applicator. Applicator 28 stores the liquid mix typically as a resin (here diisocyanate) and hardener (here an amine terminated polymer) separately in the body thereof, but injection through nozzle 28a thereof allows the two compositions to mix. Thus, in the process of pouring or applying the resilient body liquid mix, the two components are typically combined. This application and pouring step is typically done at room temperature. Moreover, it is noted that the resilient body liquid mix 13 may be self-leveling. The mix may have a viscosity of between about 200-4000 cps when it comes out of the nozzle. This step may also be done as two separate steps. First, one may separately mix the two components of the curable mix and, before it begins to set, apply it by pouring or any other suitable manner, onto the skeletal member.

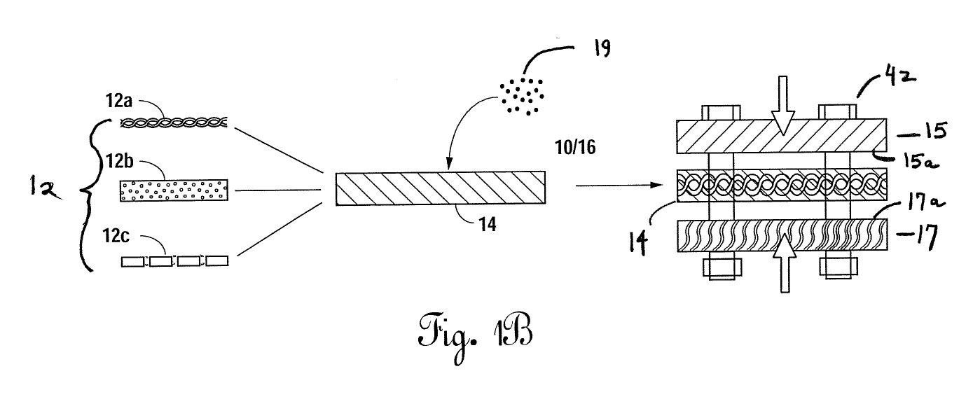

With a practice and experience, the proper amount of liquid mix for the mesh may be determined. In one embodiment, sufficient liquid mix should be applied to the mesh for it to sufficiently cover the mesh such that the resilient body contains the skeleton closer one surface than the other (see FIG. 2). For example, it has been determined that using a 10½ inch by 17 inch 22 mil aluminum wire mesh such as set forth above, one applies about 160 milliliters of mix, typically, in the crisscross or zigzag pattern as illustrated in FIG. 9. This will typically result in a gasket with an encapsulated skeleton of about 40 mil uncompressed thickness.

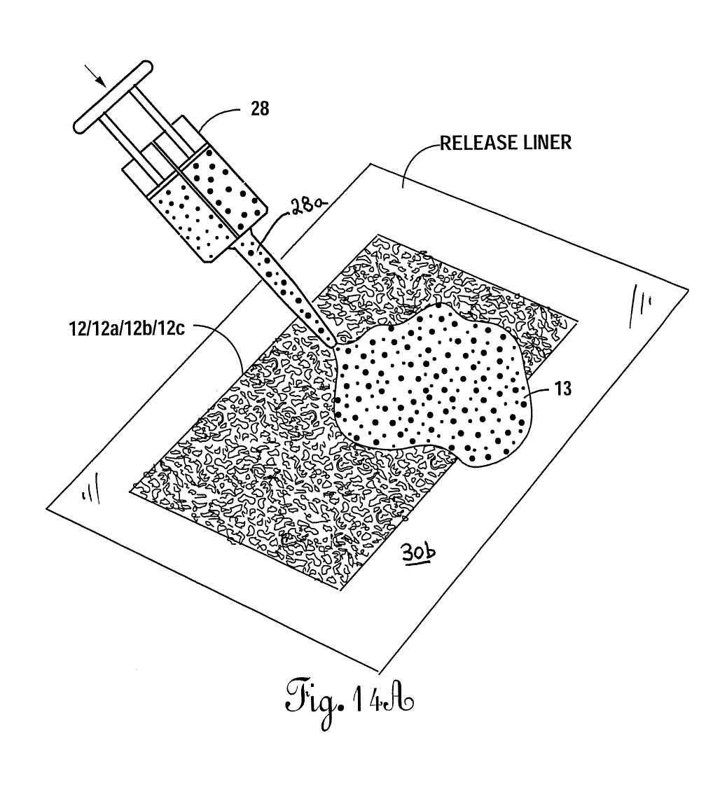

The next step in preparing Applicant's preformed gasket is to allow the liquid mix to cure. Typical time to curing (to substantially its final hardness, no longer flows or self-levels) is about 1 to 12 minutes or less at room temperature, in another embodiment, about 3-11 minutes. Upon curing a second FEP layer here 30a (see FIG. 10) may be applied to the top surface of the gasket 10 as seen in FIG. 10. This second layer of FEP material will help protect the gasket in handling and also will release easily from the surface therefrom before use.

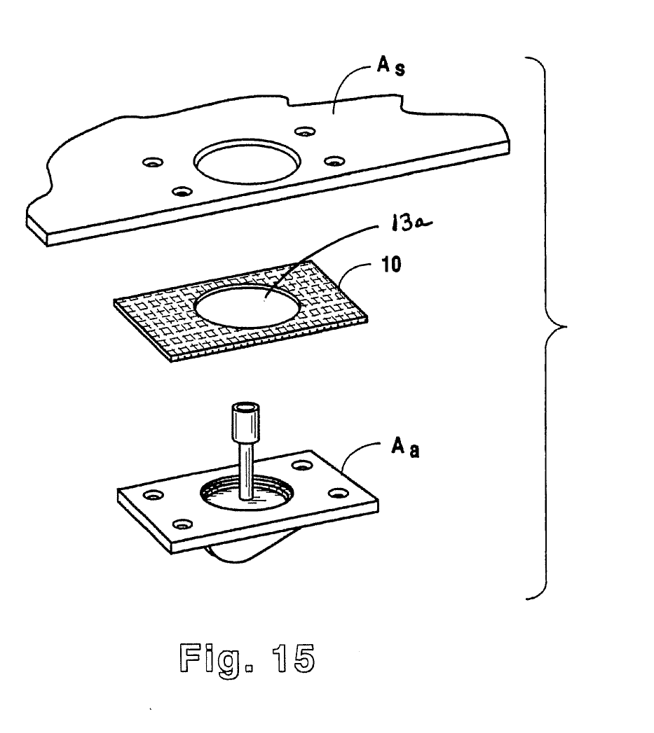

Further in FIG. 11, it is seen that gasket 10 may be cut with a die stamp machine 34 in ways known in the trade to form precut gaskets 10 to any number of suitable configurations (see, for example, FIGS. 4, 5, and 6)

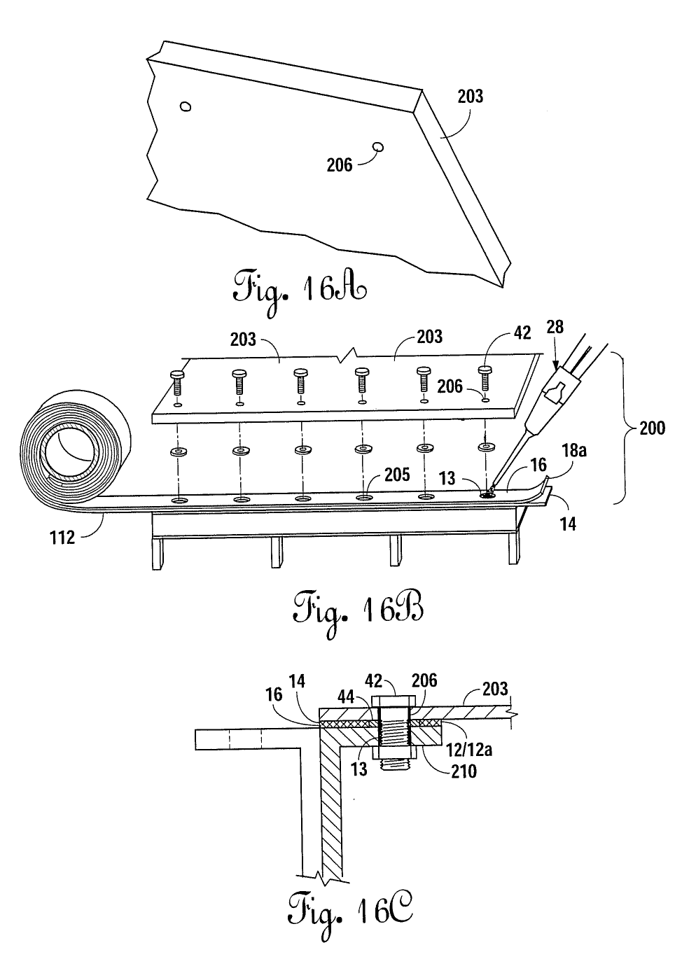

FIG. 13 illustrates a manner for making Applicant's gasket tape 16. This involves the step utilizing a table such as is illustrated in FIG. 9A and, in one embodiment, stretching a non-metallic skeletal member 12a or 12b from a roll or other stock of such material under tension atop the FEP layered table. Some tension and clamping is typically used to insure that the skeleton is maintained flat against the FEP bottom layer 30b.

The mixing and pouring step is similar to that illustrated in FIG. 9, with the same resilient body liquid polyurea mix as used in the preformed gasket 10, coating and encapsulating substantially all of the skeletal member to a thickness sufficient.

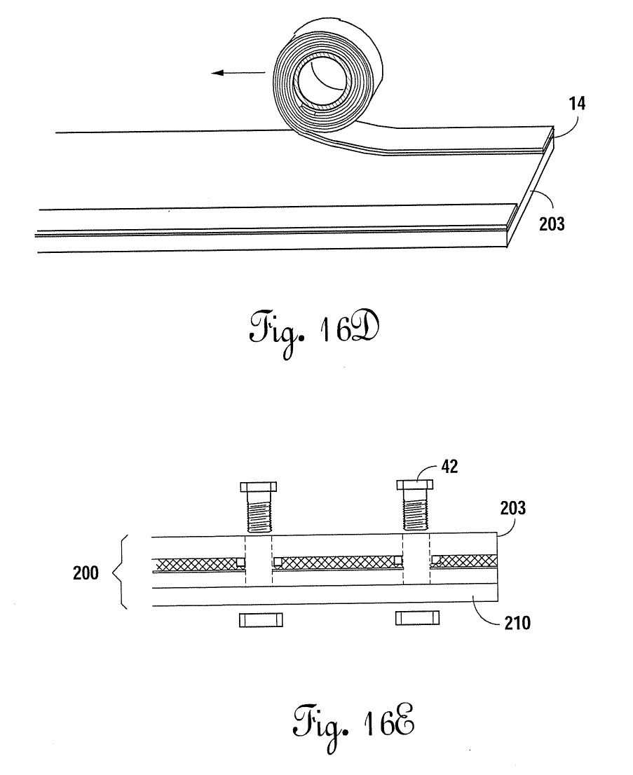

Following a period of curing, in one embodiment, in the fast time of about 3-11 minutes, the resulting product as illustrated in FIG. 14 may be cut longitudinally, covered with a top layer of FEP and rolled into a roll resulting in the gasket tape 16 illustrated in FIG. 7.

This tape may be then used in lining aluminum structural members of the frame of an aircraft such as those in cargo bays and also on aluminum mating surface beneath lavatories and galleys, where moisture may be a problem. This will help prevent access of moisture to the structural member. It is noted that use of Applicant's polyurea tape or gaskets will be self-sealing around fastener holes. This occurs when there is some deformation of the tape or gaskets at their edges under compression between the two joined mating surfaces.

In summary, it may be seen that Applicant's unique method of manufacturing either the tape or the gasket may include the step of flattening the skeletal member against a flat surface, typically a table top and more typically table top against which a flat release film 30b such as an FEP film has been placed thereon. It is seen that a curable liquid polyurea mix is combined and applied in liquid form, in one embodiment, to cover and encapsulate the skeletal member to a depth sufficient to ensure that skeletal member 12 is closer to (or adjacent (against) a bottom surface of the resulting product than to the upper surface. It is further seen that the resilient body liquid mix is typically self-leveling and will cure at room temperature. The resulting body may be then precut to a desired shape or cut to a preselected width and roller up in a form of gasket tape. It is further seen that the gasket tape, as illustrated in FIG. 7, is provided with a first protective film 18a and a second protective film 18B, typically FEP and that after by cutting, the precut gaskets are typically covered top and bottom with the same protective FEP film.

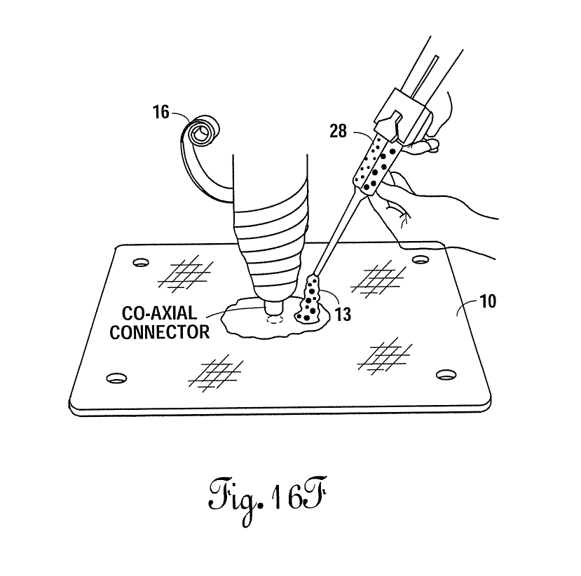

FIGS. 15 and 16F show Applicant's preformed gasket 10 ready for installation between two mating surfaces As and Aa. FIGS. 15A and 16F illustrate the use of pliable polyurea two-part sealant mix 13 as an injectable sealant (no skeleton, cures in place on the aircraft assembly), typically a polyurea resin and a diisocyanate, more typically a polyurea curable mix. Mix 13 will cure in place, and may fill any central cutout areas 13a in gasket 10 or workpiece. This will often protect against the trapping of moisture in such area. Note that this curable mix has the beneficial properties of the resilient body of Applicant's preformed gasket 10.

FIG. 16G illustrates the use of the polyurea body 14 in gasket 10 having a semi-porous (to body 14) skin 46 that adheres to the sticky body on one side thereof, which skin will reduce the tack of the gasket when it contacts the workpiece. US2013/0001894 describes such a skin and a single-sided gasket/tape, and is incorporated herein by reference. The gaskets and tapes disclosed herein may also be used as part of spacer assemblies as disclosed in U.S. Pat. No. 9,016,697, incorporated herein by reference.

The body 14 of gasket 10 may be comprised of a two-component polyurea mix 13. Two-component polyurea systems have very rapid dry time and are typically achieved after the use of catalysts as in the two-component polyurethane system. This rapid dry time is very consistent and uniform over a broad temperature range. Conventional two-component fast set polyurea systems typically contain any solvent or VOC's (volatile organic compounds), Applicant's, in one preferred embodiment, do not.

FIG. 14A illustrates an alternate preferred embodiment in which a skeleton 12 is placed on release liner 30b, without a mold. The release liner is typically on a flat surface and the flat skeleton is covered with mix 13, typically applied with applicator 28. Mix 13 is allowed to cure and the skeleton, if not pre-cut, will be cut to shape. It is noted that any of the embodiments of the gasket may have a gasket in which the bottom layer of the skeleton has only a very thin layer, in one embodiment, less than a mil of cured body 14.

Peel strength may be measured in an aluminum trough 1″ wide, 6″ long, in which the pre-cured mix is placed to about 0.045″ depth and allowed to cure at room temperature. A piece of mesh may be used in soft materials, such as an anchor to attach a force gauge. An Imada Digital Force Gauge (DP5-44R) or other force gauge may be used with a thin film grip or other suitable gripping apparatus, and the top should have an inch or so removed from the trough and attached to the gauge, that will put at a 90° angle to the trough, to measure the force that the 1″ wide strip will peel (release) at. The unit of measurement may be pounds/inch-width.

FIGS. 16A, 16B, 16C, 16D, 16E, and 16F illustrate a floorboard assembly 200, which comprises floorboard 203 mounted to a mounting member 210, the floorboard and mounting member may be in one embodiment parts of an aircraft. Floorboard 203 may have a hole 206 for receipt of fasteners 42. Fasteners 42 may be torqued down with a gasket tape 16 between the floorboards and mounting frame 210. Tape 16 may include a skeleton 12/12a (see FIG. 16c) or may be without a skeleton (see FIG. 16d). In one embodiment, tape 16 may have cut out holes 205 for receipt of two-part sealant mix 13 of polyurea as seen FIG. 16b. If sealant mix 13 is used, it may be any sealant and, in one embodiment, polyurea that is curable upon mixing and, in one embodiment self-leveling.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. A gasket or tape for sealing between two members, the two members under compression and being two parts of an aircraft, the gasket material comprising:
a flexible skeletal member; and
a flexible, deformable, elastomeric resilient polyurea body member having a tacky outer surface, the body member for substantially enclosing the skeletal member with a self-curing mix of an isocynate component and an amine terminated component, the resilient body member having a tacky top surface and a tacky bottom surface.

2. The gasket or tape of claim 1, wherein the body has a peel strength between about 2 and 7 pounds/inch width.

3. The gasket or tape of claim 1, wherein the mix has a pre-cured viscosity, when coming out of the nozzle of an applicator of between about 200 and 4500 Cps.

4. The gasket or tape of claim 1, wherein the body has a hardness after curing of between about 40 and 150 (37.5 gram half cone penetrometer).

5. The gasket or tape of claim 1, wherein the body is free from volatile organic compounds (VOC's) and solvents.

6. The gasket or tape of claim 1, wherein the self-curing mix will cure between about 3 and 11 minutes.

7. The gasket or tape of claim 1, wherein the skeleton member is a mesh.

8. The gasket or tape of claim 7, wherein the mesh is non-metal.

9. The gasket or tape of claim 7, wherein the mesh is metal.

10. The gasket or tape of claim 1, wherein skeletal member is a metallic or non-metallic open cell foam.

11. The gasket or tape of claim 1, wherein the skeletal member is a perforated or expanded sheet.

12. The gasket or tape of claim 1, wherein the body includes electrically conductive particles.

13. The gasket or tape of claim 1, wherein the flexible skeletal member is encapsulated in the body such that the body is closer to one of the top or bottom surface than the other.

14. The gasket or tape of claim 1, further including a skin for placement on one of the top or bottom surfaces.

15. The gasket or tape of claim 14, wherein the skin will allow some seepage of the body member therethrough, when under compression.

16. The gasket or tape of claim 1, wherein one of the top or bottom surface has a first peel strength and the other a second peel strength, the two peel strengths being different.

17. The gasket or tape of claim 1, wherein the gasket can withstand multiple thermal cycles and retain its resiliency and tackiness.

18. An assembly comprising:
a first aircraft part having a first surface;
a second aircraft part having a second surface;
a gasket or gasket tape for placement between the two parts, the two parts under compression, the gasket or gasket tape material comprising:
a flexible skeletal member; and
a flexible, deformable, elastomeric resilient polyurea body member having a tacky outer surface, the body member for substantially enclosing the skeletal member with a self-curing mix of an isocynate component and an amine terminated component, the resilient body member having a tacky top surface and a tacky bottom surface; and
fasteners for engaging the two parts and providing compression on the gasket or gasket tape.

19. The assembly of claim 18, wherein the body has a hardness after curing of between about 40 and 150 (37.5 gram half, cone penetrometer).

20. The assembly of claim 18, wherein the first aircraft part is a floorboard and the second aircraft part is a floorboard support surface.

21. The assembly of claim 18, wherein the first aircraft part is an outer surface of an aircraft and the second aircraft part is an aircraft antenna.

22. The assembly of claim 21, further including a coaxial cable for passing through the outer surface and connecting to the aircraft antenna, wherein the coaxial cable is wrapped in a stretchable foam tape substantially encapsulated by a polyurea body.

23. A method of making a gasket or gasket tape, the method comprising the steps of:
laying a skeletal member on a flat, release/support surface;
combining an uncured, a self-curing, two part, gas bubble-free, polyurea mix onto the skeletal member, such that the mix substantially encapsulates the skeletal member before curing;
allowing the mix to cure; and
shaping the encapsulated skeleton to the shape of a workpiece.

24. The method of claim 23, wherein the combining step is accomplished with the use of an applicator that mixes the two parts and is completed in under eleven minutes.

25. The method of claim 24, wherein the polymer mix of the combining step has a precured viscosity of between about 200 and 4500 Cps coming out of the applicator.
